(19) United States
(12) Patent Application Publication
(10) Pub. No.: US 2016/0075574 A1
(43) Pub. Date: Mar. 17, 2016

(54) FOOD WASTE DISPOSER DISCHARGE TREATMENT DEVICE

(71) Applicant: Emerson Electric Co., St. Louis, MO (US)

(72) Inventors: Randall E. Hammer, Muskego, WI (US); Brian J. Falcone, Pleasant Prairie, WI (US)

(73) Assignee: Emerson Electric Co., St. Louis, MO (US)

(21) Appl. No.: 14/848,387

(22) Filed: Sep. 9, 2015

Related U.S. Application Data
(60) Provisional application No. 62/049,433, filed on Sep. 12, 2014.

(51) Int. Cl. C02F 1/68

(52) U.S. Cl. CPC C02F 1/688

(57) ABSTRACT

A discharge treatment device includes an entry section with an inlet configured to connect to a discharge outlet of a food waste disposer. The discharge treatment device includes an exit section with an outlet configured to connect to a drain pipe and to discharge the discharge stream into the drain pipe. The discharge treatment device includes a holding section connected to the entry section and the exit section, with the holding section having an interior portion with first openings that receive the discharge stream from the entry section and second openings that discharge the discharge stream into the exit section. The holding section has a third opening for receiving a dissolvable additive pellet that dissolves in the discharge stream when the at discharge stream flows from the entry section to the exit section through the interior portion of the holding section.

### CROSS-REFERENCE TO RELATED APPLICATIONS

This application claims the benefit of U.S. Provisional Application No. 62/049,433, filed on Sep. 12, 2014. The entire disclosure of the above application is incorporated herein by reference.

### FIELD

The present disclosure relates to a food waste disposer discharge treatment device and, more particularly, to a food waste disposer discharge treatment device that introduces additives directly into a discharge stream of a food waste disposer.

### BACKGROUND

The present disclosure relates generally to a food waste disposer discharge treatment device, and more particularly, to a treatment device that passively introduces additives directly into the discharge stream of a food waste disposer. For example, in the case of a food waste disposer connected to a septic system, the additives may include septic chemicals, bio-enzymes, micro-organisms, and/or other substances to aid the septic system. For further example, in the case of a food waste disposer connected to a composting system, the additives may include micro-organisms, bacteria, and/or other composting aids or substances for the composting system.

FIG. 1 shows a prior art food waste disposer 100 coupled with an injection device 102 that introduces chemicals in liquid form into the food waste disposer 100. Such a prior art device is disclosed in U.S. Pat. No. 5,856,173 (Riley et al.), which is incorporated herein by reference.

The food waste disposer 100 is mounted to a sink, such as a kitchen sink, and comminutes food scraps into particles small enough to safely pass through household drain plumbing. The food waste disposer 100 includes an upper food conveying section 104, a lower motor section 106, and an intermediate grinding section 108 disposed between the food conveying section 104 and the motor section 106. The food conveying section 104 includes a first inlet 110 at its upper end for receiving food waste and water in a direction “A”. The food conveying section 104 also includes a second inlet 112 for receiving food waste and water in a direction “B” discharged from a dishwashing machine (not shown). The food conveying section 104 conveys food waste and water to the grinding section 108, and the injection device 102 injects chemicals in liquid form into the grinding section 108. The particulate waste, the injected water, and the injected chemicals are mixed and discharged through a discharge outlet 114 in a direction “C”.

The prior art injection device 102 includes a bottle 116 integrated with a pump 118, a bottle receiver 120, and an electromagnetic actuator 122. The bottle 116 is integrated with the pump 118 of the type that is commonly used to dispense fluid substances such as hand lotion, liquid detergent, and window cleaning fluid. The bottle 116 has a bottle cap 124 for filling the bottle 116 with chemicals. The bottle 116 is secured to the bottle cap 124 fitted into the bottle receiver 120. The bottle 116 has a pump operating tubular member 126 extending out of a collar portion 128 of the bottle cap 124. The upper part of the tubular member 126 terminates in a discharge cap 130. The discharge cap 130 is connected to the interior of the grinding section 108 through a flexible tube 132. The tube contains a check valve 134 to ensure that water that enters the grinding section 108 cannot enter the pump 118. When the tubular member 126 is plunged downward, the pump 118 dispenses a small predetermined quantity of chemicals in liquid from the bottle 116 through the discharge cap 130 and the flexible tube 132 into the interior of the grinding section 108.

The electromagnetic actuator 122, secured to a bracket 136, provides the mechanical force to the pump 118 to dispense a small predetermined quantity of chemicals in liquid form from the bottle 116. When energized, the electromagnetic actuator 122 drives a rod 138 downward, so the tubular member 126 of the pump 118 plunges downward and correspondingly brings about ejection of a small predetermined quantity of chemicals in liquid form out of the bottle 116 into the food waste disposer 100. Every time the food waste disposer 100 is turned on to carry out a grinding operation, the electromagnetic actuator 122 executes one pumping stroke to inject a small predetermined quantity of chemicals in liquid form into the food waste disposer 100.

As shown in FIG. 1, prior art injection devices, such as injection device 102, employ a complex system of tubing, pumps, and electromagnetic actuators resulting in food waste disposers with such injection devices being more expensive. Further, such injection devices cannot generally be retrofitted to existing food waste disposers, thereby requiring replacement of the entire food waste disposer upon installation. Also, the electromagnetic actuator 122 uses electricity in its operation, increasing the operating cost. Additionally, the predetermined quantity of liquid chemicals dispensed by the injection device 102 may be insufficient during longer grinding operations while excessive and wasteful during shorter grinding operations, potentially creating environmental concerns. Further, such injection devices 102 dispense only liquids and not solids.

### SUMMARY

This section provides a general summary of the disclosure and is not a comprehensive disclosure of its full scope or all of its features.

A food waste disposer discharge treatment device passively introduces additives directly into a discharge stream from a food waste disposer mounted to a sink, such as a kitchen sink. For example, in the case of a food waste disposer connected to a septic system, the additives may include septic chemicals, bio-enzymes, micro-organisms, and/or other substances to aid the septic system. For further example, in the case of a food waste disposer connected to a composting system, the additives may include micro-organisms, bacteria, and/or other composting aids or substances for the composting system. The discharge treatment device includes an entry section, an exit section, and a holding section between the entry section and the exit section. The discharge treatment device is connected to a food waste disposer through the entry section of the discharge treatment device. The holding section has an exterior portion and an interior portion connected through their internal cavities, allowing at least one pellet of additives to enter the interior portion from the exterior portion. The discharge stream from the food waste disposer first enters the discharge treatment device through the entry section. After entering the discharge treatment device, the discharge stream enters the interior portion of the holding section through at least one interior opening on the interior portion. The mixture of the discharge stream and the additives exits the holding section through the at least one bottom opening on the bottom member of the interior portion of the holding section into the drain pipe.

A discharge treatment device includes an entry section with an inlet configured to connect to a discharge outlet of a food waste disposer and to receive a discharge stream from the discharge outlet of the food waste disposer. The discharge treatment device also includes an exit section with an outlet configured to connect to a drain pipe and to discharge the discharge stream into the drain pipe. The discharge treatment device also includes a holding section connected to the entry section and the exit section, the holding section having an interior portion with at least one first opening that receives at least a portion of the discharge stream from the entry section and at least one second opening that discharges the at least the portion of the discharge stream into the exit section, and the holding section having a third opening for receiving a dissolvable additive pellet. At least a portion of the dissolvable additive pellet dissolves in the at least the portion of the discharge stream when the at least the portion of the discharge stream flows from the entry section to the exit section through the interior portion of the holding section.

A system includes a dissolvable additive pellet and a discharge treatment device having an entry section, an exit section, and a holding section connected to the entry section and the exit section. The entry section has an inlet configured to connect to a discharge outlet of a food waste disposer and to receive a discharge stream from the discharge outlet of the food waste disposer. The exit section has an outlet configured to connect to a drain pipe and to discharge the discharge stream into the drain pipe. The holding section has an interior portion with at least one first opening that receives at least a portion of the discharge stream from the entry section and at least one second opening that discharges the at least the portion of the discharge stream into the exit section and has a third opening for receiving a dissolvable additive pellet. At least a portion of the dissolvable additive pellet dissolves in the at least the portion of the discharge stream when the at least the portion of the discharge stream flows from the entry section to the exit section through the interior portion of the holding section.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a side view of a prior art food waste disposer coupled with an injection device.

FIG. 2 is a partial perspective view of a discharge treatment device of the present disclosure connected to a food waste disposer.

FIG. 3 is a perspective view of a discharge treatment device of the present disclosure.

FIG. 4 is a cut-away view of the discharge treatment device of FIG. 3, taken along line 1-1 of FIG. 3.

FIG. 5 is a cross-sectional view of another discharge treatment device.

FIG. 6 is a perspective view of another discharge treatment device of the present disclosure.

FIG. 7 is a partially exploded view of the discharge treatment device of FIG. 6.

FIG. 8 is a cut-away view of the discharge treatment device of FIG. 6.

FIG. 9 is another perspective view of the discharge treatment device of FIG. 6.

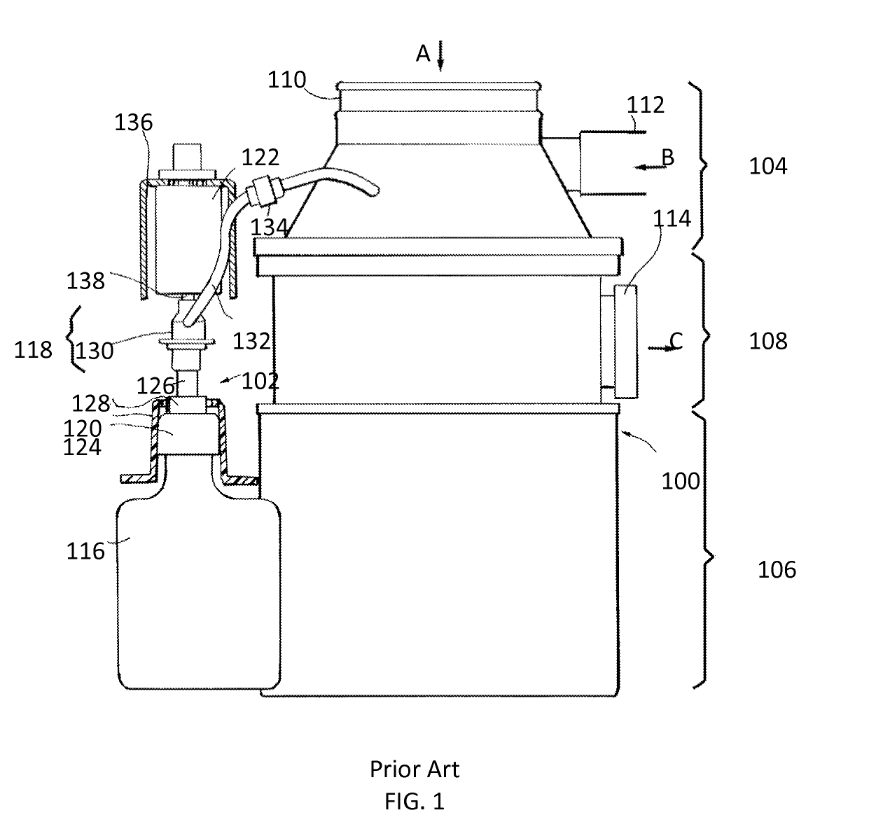

Corresponding reference numerals indicate corresponding parts throughout the several views of the drawings.

### DETAILED DESCRIPTION

Example embodiments will now be described more fully with reference to the accompanying drawings.

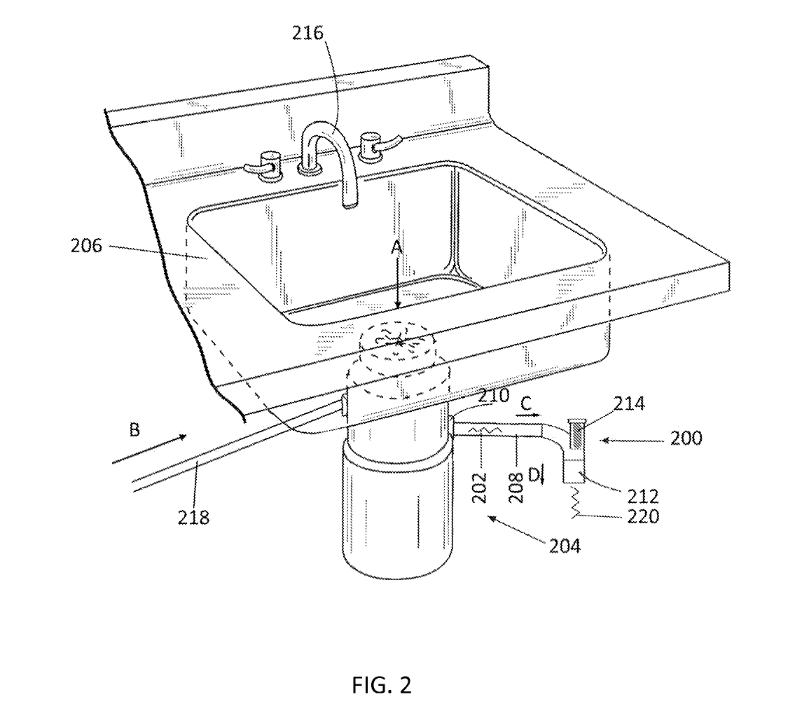

FIG. 2 shows a discharge treatment device 200 that passively introduces additives directly into a discharge stream 202 from a food waste disposer 204 mounted to a sink 206, such as a kitchen sink. For example, in the case of a food waste disposer connected to a septic system, the additives may include septic chemicals, bio-enzymes, micro-organisms, and/or other substances to aid the septic system. For further example, in the case of a food waste disposer connected to a composting system, the additives may include micro-organisms, bacteria, and/or other composting aids or substances for the composting system. The additives for the composting system may, for example, enhance or accelerate the breakdown of food waste material collected in a compost collection tank prior to being transferred to a compost pile. The discharge treatment device 200 is shown retrofitted to the food waste disposer 204 through a tail pipe 208 connected to a discharge outlet 210 of the food waste disposer 204. For example, an inlet of the discharge treatment device 200 is connected to a discharge outlet 210 of the food waste disposer 204 through a tail pipe 208. Alternatively, the inlet of the discharge treatment device 200 may connect directly to the discharge outlet 210 of the food waste disposer 204. Alternatively, an inlet of the discharge treatment device 200 may connect to the sink 206 directly. As shown in FIG. 2, an outlet of the discharge treatment device 200 is connected to a drain pipe 212. The drain pipe 212 may be connected to a septic system (not shown), that includes a septic tank or to a composting system (not shown), that includes a compost collection tank. No modification of the food waste disposer 204 and the downstream plumbing is necessary.

As shown in FIG. 2, the discharge treatment device 200 may be installed between the discharge outlet 210 of the food waste disposer 204 and a plumbing trap (not shown). In other words, in FIG. 2, the discharge treatment device 200 is installed on the upstream side of plumbing trap located in the plumbing for the sink 206. Alternatively, the discharge treatment device 200 may be installed on the downstream side of the plumbing trap located in the plumbing for the sink 206. In the case of the discharge treatment device 200 being installed downstream from the plumbing trap, the plumbing trap may contain any odor from the additives in the discharge treatment device 200 and prevent any such odor from traveling upstream through the food waste disposer 204 and into the sink 206.

The discharge treatment device 200 holds at least one pellet 214 that contains additives to be introduced into the discharge stream 202 from the food waste disposer 204. As discussed above, the additives may include may include septic chemicals, bio-enzymes, micro-organisms, and/or other substances to aid a connected septic system and/or may include may include micro-organisms, bacteria, and/or other composting aids or substances for a connected composting system. FIG. 2 shows the discharge treatment device 200 holding one pellet 214. The discharge treatment device 200 passively introduces the additives directly into the discharge stream 202 when water from the discharge stream 202 comes into contact with the pellet 214 and dissolves at least part of the pellet 214. Water in the discharge stream 202 has at least two sources. Water may enter the food waste disposer 204 from a faucet 216 assembly from a direction “A,” along with food waste introduced into the food waste disposer 204 from the sink 206. Water may also enter the food waste disposer 204 from a dish washing machine (not shown) in a direction “B” through a dishwasher discharge line 218, along with food waste introduced into the food waste disposer 204 from the dish washing machine. Because the discharge treatment device 200 is located downstream from the discharge outlet 210 of the food waste disposer 204, the discharge treatment device 200 is able to passively introduce additives into the discharge stream 202 during each dishwasher cycle and each food waste disposer 204 cycle independently.

When water in the discharge stream 202 from the food waste disposer 204 in a direction “C” comes into contact with the pellet 214 of the additives in the discharge treatment device 200, at least part of the pellet 214 dissolves in the discharge stream 202. A mixture 220 of the discharge stream 202 and the additives exits the discharge treatment device 200 into the drain pipe 212 in a direction “D.” As the pellet 214 erodes with each flow of water, the pellet 214 feeds downward by force of gravity until the pellet 214 is completely dissolved. A user may add a new pellet 214 to the discharge treatment device 200 when necessary, such as when the pellet 214 previously added is completely dissolved.

In the case of the discharge treatment device 200 being installed for use with a septic system, the discharge treatment device 200 can work with all solid versions of septic chemicals, bio-enzymes, and micro-organisms available in the marketplace, including, but not limited to, REX-BAC-T® Bacteria Blocks, RID-X® Septic System Treatment, and BIO-ACTIVE® Septic Tank Treatment. In addition to introducing septic chemicals and/or composting aids, the discharge treatment device 200 may also be used to introduce drain cleaning chemicals, root killers, and scents into the discharge stream 202. The discharge treatment device 200 can hold all forms of solid pellets 214, such as solid pellets 214 in stick form, gel form, and powder form. In some aspects of the disclosure, the discharge treatment device 200 may hold additives in liquid form. Further, the discharge treatment device 200 may include an injection mechanism, such as an electrically operated pump, to inject liquid into the discharge stream. For example, the electrically operated pump may include a battery operated pump to inject liquid into the discharge stream.

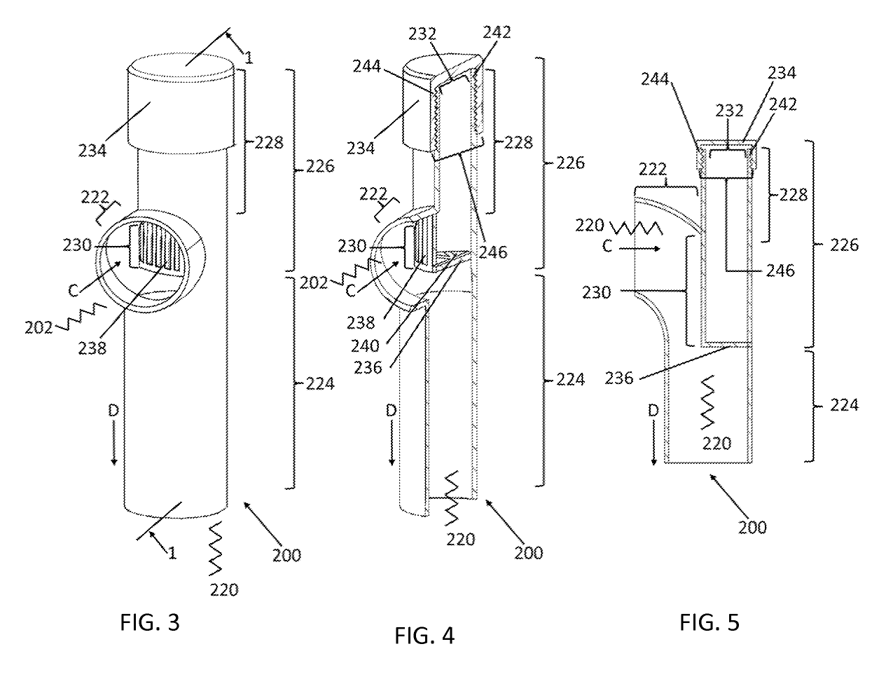

Referring to FIGS. 3 and 4, the discharge treatment device 200 includes an entry section 222, an exit section 224, and a holding section 226 between the entry section 222 and the exit section 224. The entry section 222 has at least one internal cavity enclosed by the wall of the entry section 222. The exit section 224 has at least one internal cavity enclosed by the wall of the exit section 224. The holding section 226 has at least one internal cavity enclosed by the wall of the holding section 226. The internal cavity of the entry section 222, the internal cavity of the exit section 224, and the internal cavity of the holding section 226 are connected, allowing the discharge stream 202 from the food waste disposer in a direction “C” to pass from the entry section 222 through the holding section 226 to the exit section 224.

FIGS. 3 and 4 illustrate one configuration of the entry section 222, the exit section 224, and the holding section 226 with the entry section 222 being at approximately a right angle to both the exit section 224 and the holding section 226 and the holding section 226 being collinear with the exit section 224. It is understood, however, that other configurations of the entry section 222, the exit section 224, and the holding section 226 are possible and within the scope of the present disclosure. For example, the entry section 222 and the exit section 224 may be at an obtuse angle and the entry section 222 and the holding section 226 may be at an acute angle.

The diameter of the entry section 222 and the diameter of the exit section 224 may be approximately the same while the diameter of the holding section 226 may be smaller than the diameter of the entry section 222 and the diameter of the exit section 224 as shown. Alternatively, the diameter of the entry section 222 and the diameter of the exit section 224 may be different depending on the required flow rate and the desired pellet dissolving rate. The entry section 222 is connected to a tail pipe of the food waste disposer 204 and the exit section 224 is connected to a drain pipe.

The holding section 226 has an exterior portion 228 and an interior portion 230. The exterior portion 228 has at least one internal cavity enclosed by the wall of the exterior portion 228. The interior portion 230 has at least one internal cavity enclosed by the wall of the interior portion 230. The internal cavity of the exterior portion 228 and the internal cavity of the interior portion 230 are connected. The interior portion 230 and the exterior portion 228 hold at least one pellet of additives in the internal cavity of the interior portion 230 and the internal cavity of the exterior portion 228. The interior portion 230 and the exterior portion 228 are connected through their internal cavities, allowing the at least one pellet of additives to enter the interior portion 230 from the exterior portion 228. The exterior portion 228 has an exterior opening 232 for replenishing the additives as necessary, such as when a pellet previously added to the discharge treatment device 200 is completely dissolved. The exterior opening 232 of the exterior portion 228 is optionally covered by an exterior cap 234 to prevent spillage of the discharge stream 202 from the food waste disposer out of the discharge treatment device 200.

The exterior portion 228 and the interior portion 230 of the holding section 226 may have different lengths as shown. In some aspects of the present disclosure, the exterior portion 228 and the interior portion 230 may have the same length. The exterior portion 228 and the interior portion 230 may have the same length as shown. In some aspects of the present disclosure, the exterior portion 228 and the interior portion 230 have different lengths. The exterior portion 228 and the interior portion 230 may be tubular in shape as shown. In some aspects of the present disclosure, the exterior portion 228 and the interior portion 230 may have other shapes such as cubical or irregular shapes. In some aspects of the present disclosure, the exterior portion 228 may not be visible because the exterior cap 234 may completely enclose the exterior portion 228.

FIG. 4 shows a cut-away view of the discharge treatment device 200 of FIG. 3 taken along line 1-1 of FIG. 3. The interior portion 230 optionally has a bottom member 236 that holds the at least one pellet. The discharge stream 202 from the waste disposer in a direction “C” may enter the interior portion 230 of the holding section 226 through at least one interior opening 238 on the interior portion 230. FIG. 4, for example, shows two of the interior openings 238. The at least one interior opening 238 may be, but is not limited to, a slot, a hole, a matrix, a filter, a permeable surface, a porous surface, a screen, and/or any other suitable surface permeable to water. The number of interior openings 238 and the type interior openings 238 may be based on the required flow rate and the desired pellet dissolving rate.

After dissolving part of the at least one pellet of additives, the mixture 220 of the discharge stream 202 and the additives exits the holding section 226 through at least one bottom opening 240 on the bottom member 236 into a drain pipe in a direction “D.” FIG. 4, for example, shows three bottom openings 240. The at least one bottom opening 240 may be, but is not limited to, a slot, a hole, a matrix, a filter, a permeable surface, a porous surface, a screen, and/or any other suitable surface permeable to water. The number of bottom openings 240 and the type of bottom openings 240 may be based on the required flow rate and the desired pellet dissolving rate.

To secure the exterior cap 234 to the holding section 226, the exterior portion 228 optionally has an externally threaded cylindrical portion 242 formed on it close to the exterior opening 232. The exterior cap 234 optionally may have an internally threaded cylindrical part 244 formed on it near a cap opening 246 for screwing onto the threaded cylindrical part of the exterior portion 228. Other mechanisms of securing the exterior cap 234 to the exterior portion 228 include the use screws with bolts, clamps, twist ties, cable ties, hooks, pins, and other suitable fastening mechanisms.

FIG. 5 shows a cross-sectional view of a discharge treatment device 200. In FIG. 5, for example, the entry section 222 slopes downward into the holding section 226 and exit section 224, as opposed to the exterior wall of the entry section meeting the exterior wall of the holding section 226 at a right angle, as shown in FIGS. 3 and 4, for example.

Referring to FIGS. 3, 4, and 5, an inlet of the entry section 222 of the discharge treatment device 200 may be connected to a discharge outlet of a food waste disposer directly by a plumbing nut (not shown). Other exemplary ways to connect a food waste disposer to the discharge treatment device 200 are recited, for example, in U.S. Pat. No. 6,007,006 (Engel et al.), which is incorporated herein by reference. Alternatively, the inlet of the entry section 222 of the discharge treatment device 200 may be connected to a tailpipe that is connected to a food waste disposer by plumbing connection methods such as the use of fasteners, threaded pipe, solvent welding, soldering, brazing, welding, compression fittings, flare fittings, flange fittings, mechanical fittings, grooved pipe fittings, and crimped or pressed fittings. Alternatively, the entry section 222 of the discharge treatment device 200 may be connected to a sink by plumbing connection methods such as the use of fasteners, threaded pipe, solvent welding, soldering, brazing, welding, compression fittings, flare fittings, flange fittings, mechanical fittings, grooved pipe fittings, and crimped or pressed fittings.

The exit section 224 of the discharge treatment device 200 may be connected to a drain pipe by plumbing connection methods such as the use of fasteners, threaded pipe, solvent welding, soldering, brazing, welding, compression fittings, flare fittings, flange fittings, mechanical fittings, grooved pipe fittings, and crimped or pressed fittings.

The discharge treatment device 200 may be composed of metallic materials such as aluminum, copper, and stainless steel. The discharge treatment device 200 may be formed by powdered metal methods. Alternatively, the discharge treatment device 200 may be made of a polymeric material or a composite material. The discharge treatment device 200 may be formed by injection molding methods such as insert plastic injection molding, metal injection molding, or by casting methods such as die-casting or investment casting. The discharge treatment device 200 may be made of a molding process from a polymeric material such as, but not limited to, polypropylene, polyamide, or the like. Alternatively, the discharge treatment device 200 may be made partially from translucent and transparent materials to enable a user to visually determine the amount of the pellet 214 remaining. The discharge treatment device 200 may be made entirely of translucent and transparent materials.

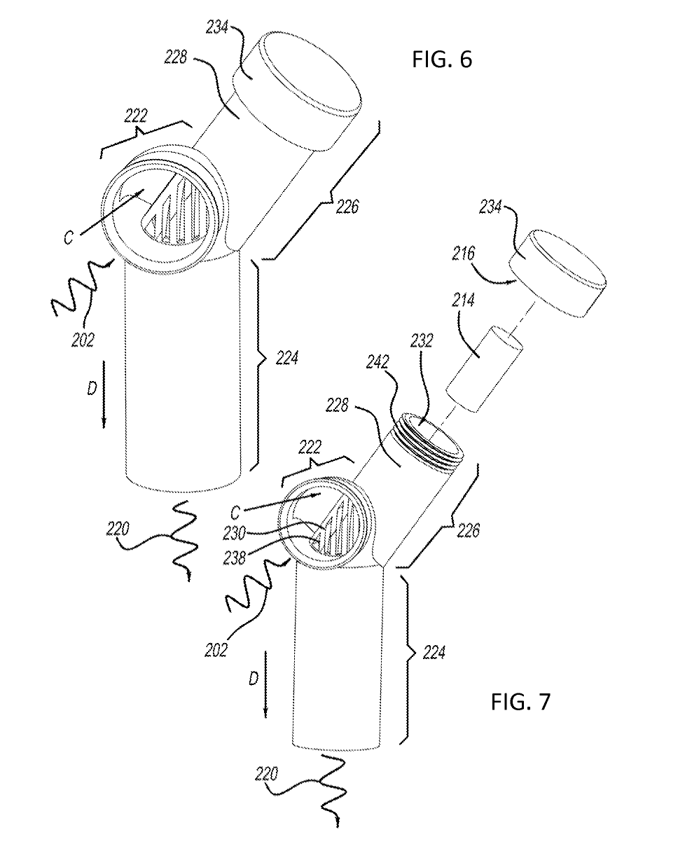

FIGS. 6, 7, 8, and 9 show further aspects of the present disclosure. FIG. 6 demonstrates one configuration of the entry section 222, the exit section 224, and the holding section 226 with the entry section 222 being at approximately right angle to both the exit section 224 and the holding section 226, while the exit section 224 and the holding section 226 are at an obtuse angle. The diameter of the entry section 222 and the diameter of the exit section 224 may be approximately the same while the diameter of the holding section 226 may be smaller than the diameter of the entry section 222 and the diameter of the exit section 224 as shown.

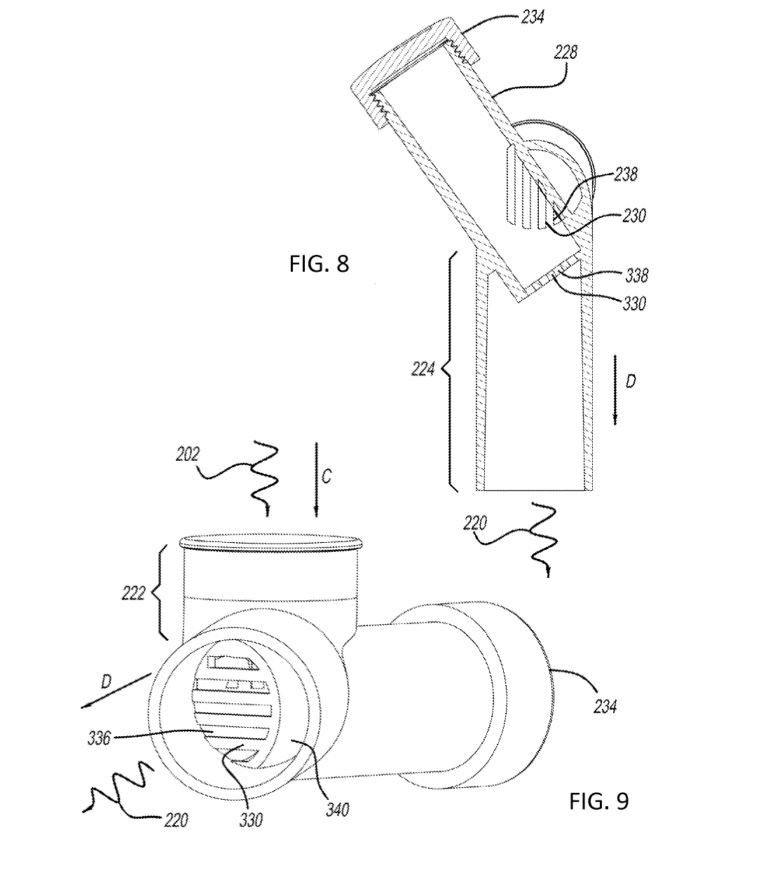

The discharge stream 202 from the waste disposer may enter the interior portion 230 of the holding section 226 in a direction “C” through the at least one interior opening 238 on the interior portion 230. FIGS. 6 and 7, for example, show four interior openings 238. After dissolving at least part of the pellet 214 of additives, the mixture 220 of the discharge stream 202 and the additives exits the holding section 226 through at least one bottom opening 330 on the bottom member 336 and flows into the drain pipe in a direction “D,” as shown in FIGS. 8 and 9. The number and type of interior openings 238 and bottom openings 330 are chosen based on the required flow rate and the desired pellet dissolving rate. Alternatively, the interior portion 230 may not have any bottom member or bottom opening.

Referring to FIG. 7, to use the discharge treatment device 200, a user may insert the at least one pellet 214 of additives into the holding section 226 through the exterior opening 232 of the exterior portion 228. After adding the at least one pellet 214 to the holding member, the user may screw the exterior cap 234 onto the externally threaded cylindrical portion 242 of the exterior portion 228 to secure the exterior cap 234 to the holding section 226.

The discharge treatment device 200 with aspects of the present disclosure has fewer parts, resulting in lower cost. Additionally, because the discharge treatment device 200 may be retrofitted to the food waste disposer 204, the initial cost of installing the discharge treatment device 200 to the food waste disposer 204 is lower. Because the amount of chemicals dissolved is proportional to the amount of the discharge stream from the food waste disposer, the discharge treatment device 200 may introduce the appropriate amounts of additives, thus lowering the operating cost. Introducing the appropriate amounts of additives maximizes the effectiveness, minimizes waste, and lessens the environmental impact of the additives. The operation of the discharge treatment device 200 does not require electricity, further lowering the operating cost. Furthermore, this passive introduction of additives avoids the need of pouring them down the drain or directly into, for example, a septic tank or compost collection tank. A user may simply open the faucet and run water into the food waste disposer 204 to introduce additives into the septic system or composting system.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the orientation of the figures, which show the typical orientation of the discharge treatment device 200 connected to the food waste disposer 204.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A discharge treatment device comprising:
an entry section with an inlet configured to connect to a discharge outlet of a food waste disposer and to receive a discharge stream from the discharge outlet of the food waste disposer;
an exit section with an outlet configured to connect to a drain pipe and to discharge the discharge stream into the drain pipe;
a holding section connected to the entry section and the exit section, the holding section having an interior portion with at least one first opening that receives at least a portion of the discharge stream from the entry section and at least one second opening that discharges the at least the portion of the discharge stream into the exit section, and the holding section having a third opening for receiving a dissolvable additive pellet;
wherein at least a portion of the dissolvable additive pellet dissolves in the at least the portion of the discharge stream when the at least the portion of the discharge stream flows from the entry section to the exit section through the interior portion of the holding section.

2. The discharge treatment device of claim 1, wherein the interior portion of the holding section includes a bottom member that includes the at least one second opening and wherein the holding section is configured such that the pellet is held by gravity against the bottom member when the outlet of the exit section is connected to the drain pipe.

3. The discharge treatment device of claim 1, further comprising a removable cap selectively attachable to the holding section that covers the third opening to prevent the at least the portion of the discharge stream from exiting the third opening.

4. The discharge treatment device of claim 1, wherein the holding section is configured at an obtuse angle to the exit section and at a right angle to the entry section.

5. The discharge treatment device of claim 1, wherein the holding section is configured at a right angle to the entry section and is collinear with the exit section.

6. The discharge treatment device of claim 1, wherein a diameter of the holding section is less than a diameter of the entry section and less than a diameter of the exit section.

7. The discharge treatment device of claim 1, wherein the at least one first opening includes at least one of a slot, a hole, a matrix, a filter, a permeable surface, a porous surface, and a screen.

8. The discharge treatment device of claim 1, wherein the at least one second opening includes at least one of a slot, a hole, a matrix, a filter, a permeable surface, a porous surface, and a screen.

9. The discharge treatment device of claim 1, further comprising a tailpipe configured for connecting the inlet of the entry section to the discharge outlet of the food waste disposer.

10. The discharge treatment device of claim 1, wherein the holding section includes a portion of at least one of translucent material and transparent material configured to allow visual inspection of the dissolvable additive pellet within the holding section.

11. A system comprising:
a dissolvable additive pellet; and
a discharge treatment device having an entry section, an exit section, and a holding section connected to the entry section and the exit section, the entry section having an inlet configured to connect to a discharge outlet of a food waste disposer and to receive a discharge stream from the discharge outlet of the food waste disposer, the exit section having an outlet configured to connect to a drain pipe and to discharge the discharge stream into the drain pipe, and the holding section having an interior portion with at least one first opening that receives at least a portion of the discharge stream from the entry section and at least one second opening that discharges the at least the portion of the discharge stream into the exit section and having a third opening for receiving a dissolvable additive pellet;
wherein at least a portion of the dissolvable additive pellet dissolves in the at least the portion of the discharge stream when the at least the portion of the discharge stream flows from the entry section to the exit section through the interior portion of the holding section.

12. The system of claim 11, wherein the dissolvable additive pellet includes a substance to aid a septic system, including at least one of septic chemicals, bio-enzymes, and micro-organisms.

13. The system of claim 11, wherein the dissolvable additive pellet includes a composting aid for a composting system, including at least one of micro-organisms and bacteria.

14. The system of claim 11, wherein the interior portion of the holding section includes a bottom member that includes the at least one second opening and wherein the holding section is configured such that the pellet is held by gravity against the bottom member when the outlet of the exit section is connected to the drain pipe.

15. The system of claim 11, further comprising a removable cap selectively attachable to the holding section that covers the third opening to prevent the at least the portion of the discharge stream from exiting the third opening.

16. The system of claim 11, wherein a diameter of the holding section is less than a diameter of the entry section and less than a diameter of the exit section.

17. The system of claim 11, wherein the at least one first opening includes at least one of a slot, a hole, a matrix, a filter, a permeable surface, a porous surface, and a screen.

18. The system of claim 11, wherein the at least one second opening includes at least one of a slot, a hole, a matrix, a filter, a permeable surface, a porous surface, and a screen.

19. The system of claim 11, further comprising a tailpipe configured for connecting the inlet of the entry section to the discharge outlet of the food waste disposer.

20. The system of claim 11, wherein the holding section includes a portion of at least one of translucent material and transparent material configured to allow visual inspection of the dissolvable additive pellet within the holding section.
